(19) United States
(12) Patent Application Publication
(10) Pub. No.: US 2007/0211476 A1
(43) Pub. Date: Sep. 13, 2007

(54) Intermediary base for fairy light lampshade having rhombus faces

(76) Inventor: Yong-Tie Jian, Banciao City (TW)

Correspondence Address: INTELLECTUAL PROPERTY / TECHNOLOGY LAW, PO BOX 14329, RESEARCH TRIANGLE PARK, NC, 27709, US

(21) Appl. No.: 11/366,686

(22) Filed: Mar. 2, 2006

(51) Int. Cl. F21V 15/00

(52) U.S. Cl. 362/362

(57) ABSTRACT

An intermediary base for fairy light lampshade having rhombus faces to be installed on a lampstand of a conventional fairy light so that a lampshade having diamond-like rhombus faces can be additionally installed on the conventional fairy light, which is integrally made by molding plastics. The intermediary base has threads provided on the upper portion thereof for threadedly connecting with the lampshade, and has a lampstand hole provided on the center of the bottom thereof for inserting therein the lampstand. A resilient locking tongue is provided on the front side of the lampstand hole, and a locking-tongue button is provided on the locking tongue for controlling the locking and unlocking between the locking tongue and the lampstand.

### FIELD OF THE INVENTION

It will surely increase much aesthetic feeling to hang strings of small light bulbs capable of shining and glittering (luminaries) on an article to be decorated such as a Christmas tree. In particular, small colorful and shinning light bulbs controlled by transistors in recent days are more beautiful and eye-dazzling, and it has been the inventor's idea to additionally install a lampshade having rhombus faces on the small light bulb for making the light more glorious due to the refraction. However, the size of such a fairy light is very small, and it is difficult to additionally install a lampshade onto the original lampstand thereof. Although it is technically practicable to replace the lampstand, yet it is not commercially easy to replace all the conventional lampstands in the market. Thus an intermediary base of the present invention, which can rotatedly connect with a lampshade at one end and is provided with a lampstand hole on the center of the other end for inserting therein a conventional lampstand, is provided. Therefore, a general and conventional fairy light can be easily provided with a lampshade having rhombus faces to make the light more gorgeous due to the refraction of the rhombus faces of the lampshade. The intermediary base of the present invention can be made of plastic materials. It is very convenient to use the present invention; when the lampstand is inserted into the lampstand hole, locking buttons will be locked up automatically, and the lampstand can be easily taken out therefrom by pulling the locking buttons.

### BACKGROUND TO THE INVENTION

Generally, the size of a single fairy light is very small, so it is technically difficult to additionally install a lampshade thereon; besides, no protection is needed therefor; therefore, there are no similar designs of installation of a lampshade in the market. The lampshade having rhombus faces enabling the light more gorgeous is newly invented by the inventor, and there are no similar designs in the market.

### SUMMARY OF THE INVENTION

The object of hanging strings of multicolor bulbs on an article to be decorated such as a Christmas tree is to increase the aesthetic feeling. The effect of aesthetic feeling will be obviously increased by additionally installing lampshades having rhombus faces capable of producing refracted light on the bulbs. However, the size of bulbs is small and the cost for additionally installing lampshades thereon is high, which may not be easy for people to do so. The present invention is thus designed to make the installation of additional lampshades become easy. A simple intermediary base is provided, which can be put on a conventional lampstand so that a lampshade having diamond-like rhombus faces capable of increasing brilliance can be easily rotatedly installed on the small bulb to greatly increase the aesthetic feeling of the light via the refraction of the rhombus faces of the lampstand.

### BRIEF DESCRIPTION OF THE DRAWINGS

The structure of the present invention will now be described by referring to the accompanying drawings, in which:

FIG. 1 is a schematic view showing a string of conventional fairy lights;

FIG. 2 is an enlarged view showing portion A of FIG. 1;

FIG. 3 is an exploded view showing the combination of the conventional lamp in FIG. 2;

FIG. 4A is the front view of the lampstand 2;

FIG. 4B is the top view of the lampstand 2;

FIG. 4C is the left side view of the lampstand 2;

FIG. 5 is a schematic view showing a string of fairy lights on which the intermediary bases 4 of the present invention with lampshades 5 further installed thereon are installed;

FIG. 6 is an enlarged view showing portion B of FIG. 5;

FIG. 7A is the front view of the intermediary base 4 of the present invention;

FIG. 7B is the top view of the intermediary base 4 of the present invention;

FIG. 7C is the left side view of the intermediary base 4 of the present invention (the left and right sides being symmetrical);

FIG. 7D is the bottom view of the intermediary base 4 of the present invention; and

FIG. 8 is a sectional view taken from line 8-8 in FIG. 7A.

### DESCRIPTION OF PREFERRED EMBODIMENTS

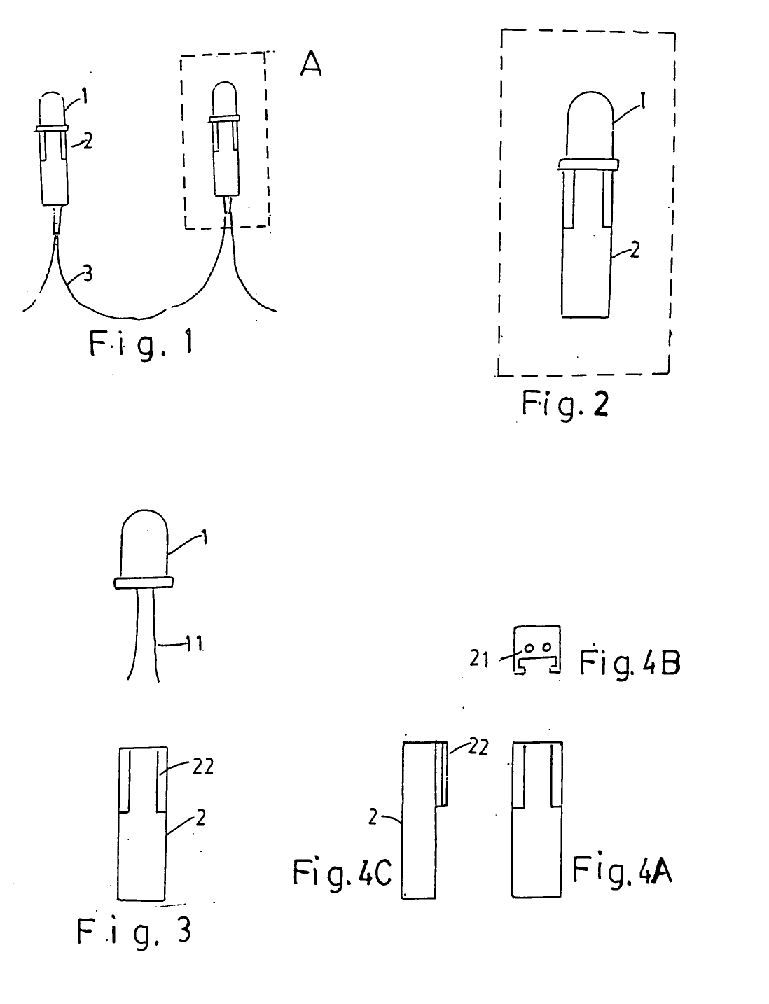

FIG. 1 is a schematic view showing a string of conventional fairy lights, and FIG. 2 is an enlarged view showing portion A of FIG. 1. It can be seen from these figures that a lamp is composed of a bulb 1 and a lampstand 2, and is stringed with others via electric wires 3.

FIG. 3 is an exploded view showing the combination of the conventional lamp in FIG. 2, FIG. 4A is the front view of the lampstand 2, FIG. 4B is the top view of the lampstand 2, and FIG. 4C is the left side view of the lampstand 2. It can be seen from these figures that there are two tentacle-like conducting wires 11 extending from the bottom of the bulb 1, and the two conducting wires are inserted into conducting holes 21 on the top of the lampstand 2 to combine the bulb 1 and the lampstand 2, as shown in FIG. 2. In the upper portion of the conventional lampstand, there are two protruding hanging buttons 22 provided on both edges of the front side thereof for fixing the lampstand as necessary.

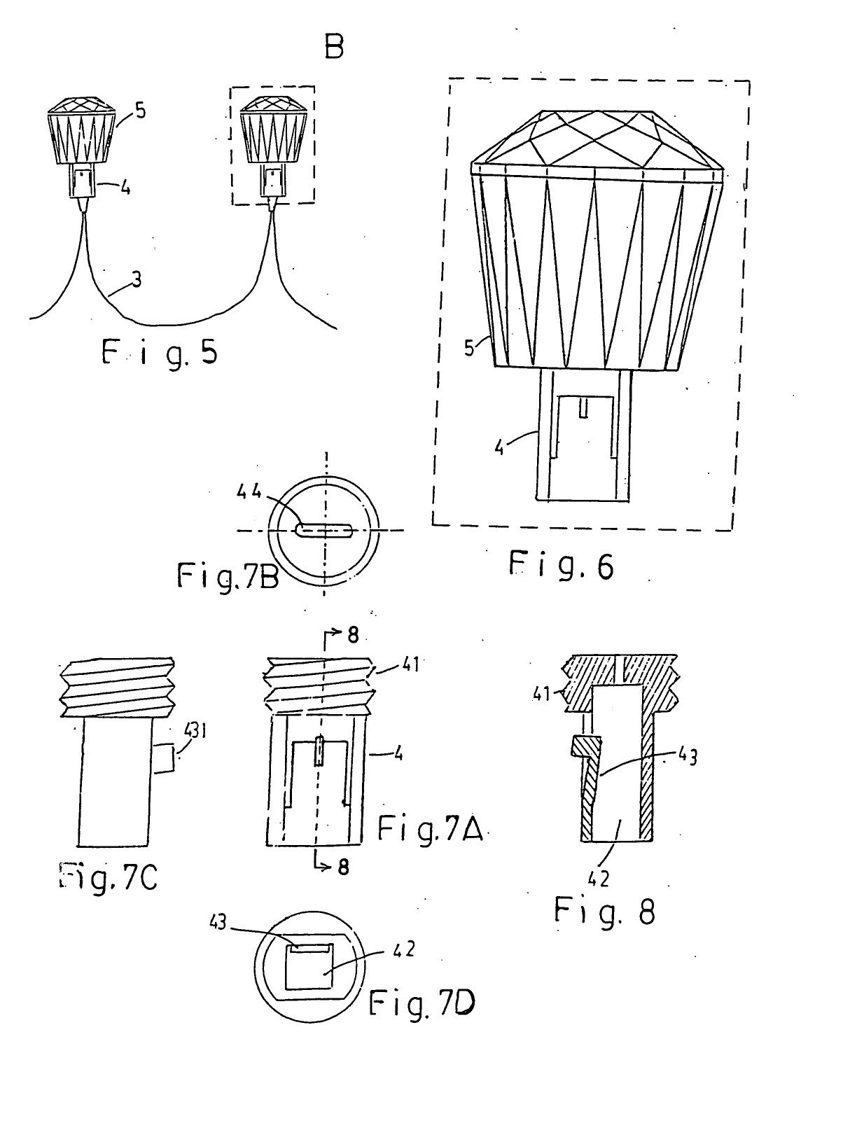

FIG. 5 is a schematic view showing a string of fairy lights on which the intermediary bases 4 of the present invention with lampshades 5 further installed thereon are installed, and FIG. 6 is an enlarged view showing portion B of FIG. 5. At this time, the bulb is covered with the lampshade 5, and the lampstand 2 is hide inside the intermediary base 4 (details will be described later); also, as can be seen from these figures, the lampshade 5 has diamond-like rhombus faces on its outer appearance, enabling the light more glorious due to the refraction.

FIG. 7A is the front view of the intermediary base 4 of the present invention, FIG. 7B is the top view of the intermediary base 4 of the present invention, FIG. 7C is the left side view of the intermediary base 4 of the present invention (the left and right sides being symmetrical), FIG. 7D is the bottom view of the intermediary base 4 of the present invention, and FIG. 8 is a sectional view taken from line 8-8 in FIG. 7A. This intermediary base has threads 41 provided on the upper portion thereof for threadedly connecting with the lampshade 5, and has a square lampstand hole 42 provided on the center of the bottom thereof. The shape and size of this hole adapt to those of the lampstand 2. When installation, the lampstand 2 is firstly inserted into this hole, and the front side of the lampstand must face upward upon insertion. When the hanging buttons 22 of the lampstand 2 are against a locking tongue 43 of the intermediary base 4, the locking tongue 43 that is resilient can be easily pushed back. Upon the hanging buttons 22 of the lampstand pass through the locking tongue 43, the locking tongue 43 immediately press on the lower end of the hanging buttons 22 of the lampstand due to the resilience of itself to securely fix the lampstand 2 in the intermediary base 4. Then, the conducting wires 11 extending from the bottom of the bulb 1 as shown in FIG. 3 are inserted into the wire hole 44 on the top of the intermediary base 4. After the lampshade is rotatedly installed thereon, the installation is thus completed as shown in FIG. 6. If the lampstand is intended to be taken out from the intermediary base 4, the locking-tongue button 431 can be pulled upward to unlock the locking effect between the locking tongue 43 and the hanging buttons 22 of the lampstand 2 so that the lampstand can be easily taken out.

It can be understood from the above description that the lampshade can not be used on a general fairy light without the intermediary base, and with the intermediary base, the lampshade having diamond-like rhombus faces can be easily installed on the general and conventional fairy light to make the light more glorious.

The intermediary base of the present invention is embodied by integrally molding and casting materials such as plastics into the shape as shown in FIGS. 7 and 8, in which the size of the lampstand hole 42 must be designed in accordance with the specification of conventional lampstands so as to adapt to the lampstands.

What is claimed is:

1. An intermediary base for fairy light lampshade having rhombus faces to be installed on a lampstand of a conventional fairy light so that a lampshade having rhombus faces can be additionally installed on the conventional fairy light to increase brilliance, which is characterized in that: the intermediary base has threads provided on the upper portion thereof for threadedly connecting with the lampshade, and has a square lampstand hole provided on the center of the bottom thereof and adapted to the insertion of the lampstand; there are a locking tongue 43 that is slightly and resiliently inclined inward provided on the front side of the lampstand hole, and a protruding locking-tongue button provided thereon so that the intermediary base can be arbitrarily assembled to and detached from the lampstand of the fairy light; thus a conventional fairy light can be provided with a lampshade having diamond-like rhombus faces for increasing brilliance.
